(19) United States
(12) Patent Application Publication
(10) Pub. No.: US 2015/0153613 A1
(43) Pub. Date: Jun. 4, 2015

(54) DISPLAY PANEL AND MANUFACTURING METHOD THEREOF

(71) Applicant: INNOLUX CORPORATION, MIAO-LI COUNTY (TW)

(72) Inventors: HUA PIN CHEN, MIAO-LI COUNTY (TW); HUAN KUANG PENG, MIAO-LI COUNTY (TW)

(21) Appl. No.: 14/541,232

(22) Filed: Nov. 14, 2014

(30) Foreign Application Priority Data
Dec. 4, 2013 (TW) 102144368

(51) Int. Cl. G02F 1/1335

(52) U.S. Cl. CPC G02F 1/133512; G02F 1/1336; G02F 1/133514

(57) ABSTRACT

A display panel includes a first substrate, a second substrate, a liquid crystal layer and a light shielding layer. The display panel has a display area and a non-display area surrounding the display area. The first substrate has a first lower surface. The second substrate has a second upper surface and a second lower surface opposite to the second upper surface. The liquid crystal layer is disposed between the first lower surface and the second upper surface. The light shielding layer is disposed on the second lower surface of the second substrate.

### BACKGROUND

1. Field of the Invention

The instant disclosure relates to a display panel, in particular, relates to a display panel having a light shielding layer.

2. Description of Related Art

At present, the commonly used image display device, such as a Liquid Crystal Display (LCD), generally includes an image display panel and a backlight module. The image display panel generally includes a color filter substrate and an active element array substrate, and is formed by assembling the color filter substrate and the active element array substrate.

Generally speaking, a light shading adhesive is used for adhering the display panel to the backlight module during the assembly of the image display devices and also reducing the incident light leakage from the backlight module. However, in consideration of the assembly tolerances of the display panel with respect to the backlight module, it is difficult to completely shield the incident light from the backlight module by the light shading adhesive, thereby causing bright lines to appear along the edge of the display area. It is need to concern bright lines appear the along edge of the display area, especially in narrow border display device.

This is particularly the case when a narrow border display device is concerned, which can be more easily subjected to the bright line phenomenon.

### SUMMARY OF THE INVENTION

An embodiment of the instant disclosure provides a display panel which includes a light shielding layer for reducing light leakage.

An embodiment of the instant disclosure provides a display panel having a display area and a non-display area surrounding the display area. The display panel includes a first substrate, a second substrate, a liquid crystal layer and a light shielding layer. The first substrate has a first lower surface. The second substrate has a second upper surface and a second lower surface opposite to the second upper surface. The liquid crystal layer is disposed between the first lower surface and the second upper surface. The light shielding layer is disposed on the second lower surface of the second substrate, and at least a portion of light shielding layer is disposed within the non-display area. The thickness of the light shielding layer is between 0.08 micrometer and 4 micrometer.

An embodiment of the instant disclosure provides a display panel having a display area and a non-display area surrounding the display area. The display panel includes a first substrate, a second substrate, a liquid crystal layer and a light shielding layer. The first substrate has a first lower surface. The second substrate has a second upper surface and a second lower surface opposite to the second upper surface, and the second lower surface defines a boundary line corresponding to the boundary between the display area and the non-display area. The liquid crystal layer is disposed between the first lower surface and the second upper surface. The light shielding layer is disposed on the second lower surface of the second substrate and adjacent to the boundary, and there is a shortest distance D an edge of between the light shielding layer and the boundary line, wherein the shortest distance D is more than 0 micrometer and equal or less than 100 micrometer.

An embodiment of the instant disclosure provides a method for manufacturing a display panel which improves the present display panel process.

An embodiment of the instant disclosure provides a method for manufacturing a display panel. The method for manufacturing a display panel includes the following steps. The first substrate and the second substrate are provided, wherein the first substrate includes a first lower surface, and the second substrate has a second upper surface and a second lower surface opposite to the second upper surface. The liquid crystal layer is provided between the first lower surface and the second upper surface. The first substrate and the second substrate are joined together. The light shielding layer is formed on the second lower surface of the second substrate by using a photolithography process.

In summary, the instant disclosure provides the light shielding layer. The light shielding layer is located on the second lower surface of the second substrate. In comparison with the space between conventional black matrix and back light module, the distance between the light shielding layer and back light module is shorter. Namely, the light shielding layer is more close to back light module. Hence, it is possible to reduce the incident light leakage of the backlight module and thereby to reduce the probability of large angle light leakage.

In addition, the embodiments of the instant disclosure provide a method for manufacturing display panel. The method is used to produce the light shielding layer by using a photolithography process. A frame-shaped light shielding layer surrounding the display area is formed by using a photomask on the covering layer. In practice, there is a shortest distance between the inner edge of the light shielding layer and the boundary of the display area, and the shortest distance is derived from the assembly tolerances (assembly-related tolerances). The manufacturing precision of the light shielding layer can be improved by using the photolithography process. In addition, the thickness of the light shielding layer can be reduced by using the photolithography process. Hence, the probability of generating air bubbles which may be generated during attaching the lower polarizing film to the light shielding layer is reduced by reducing the level difference between the lower polarizing film and the light shielding layer. Hence, the manufacturing precision of the light shielding layer becomes high, and the thickness of the light shielding layer is thin so that it can be more suitable for a narrow border display device.

In order to further understand the techniques, means and effects of the instant disclosure, the following detailed descriptions and appended drawings are hereby referred, such that, through which, the purposes, features and aspects of the instant disclosure can be thoroughly and concretely appreciated; however, the appended drawings are merely provided for reference and illustration, without any intention to be used for limiting the instant disclosure.

### BRIEF DESCRIPTION OF THE DRAWINGS

FIG. 1A illustrates a cross-sectional view of a display panel in accordance with a first embodiment of the instant disclosure.

FIG. 1B illustrates a cross-sectional view of a display panel in accordance with a second embodiment of the instant disclosure.

FIGS. 2A to 2D are schematic views illustrating steps of the display panel manufacturing method in accordance with the first embodiment of the instant disclosure.

### DETAILED DESCRIPTION OF THE PREFERRED EMBODIMENTS

In the accompanying drawings show some exemplary embodiments, and a more detailed description of various embodiments with reference to the accompanying drawings in accordance with the present disclosure is set forth below. It is to be understood that the concept of the invention may be embodied in many different forms and should not be construed as limited to the embodiment set forth herein. To be more precisely, the exemplary embodiments set forth herein are provided to a person of ordinary skilled in the art to thoroughly and completely understand contents disclosed herein and fully provide the spirit of the invention. In each of the drawings, the relative size, proportions, and depiction of the layers and regions in the drawings may be exaggerated for clarity and precision, and in which like numerals indicate like elements.

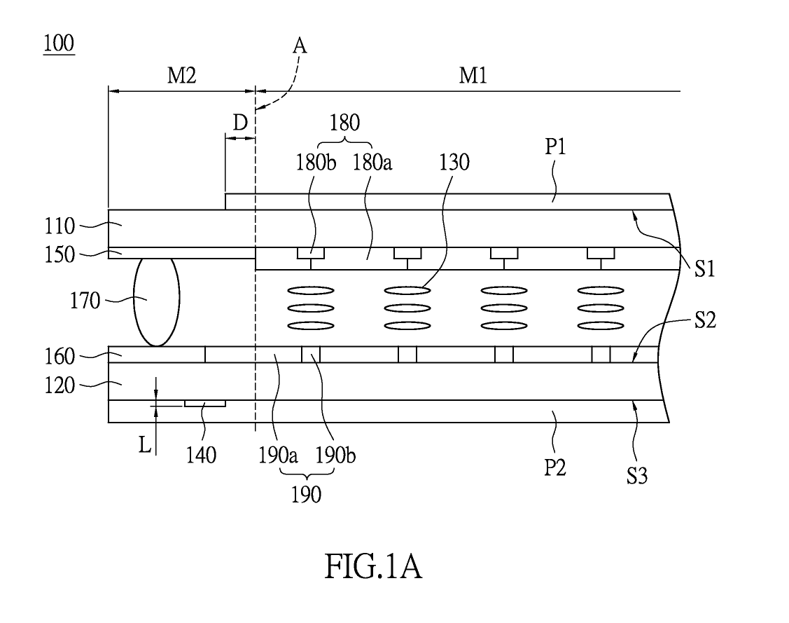

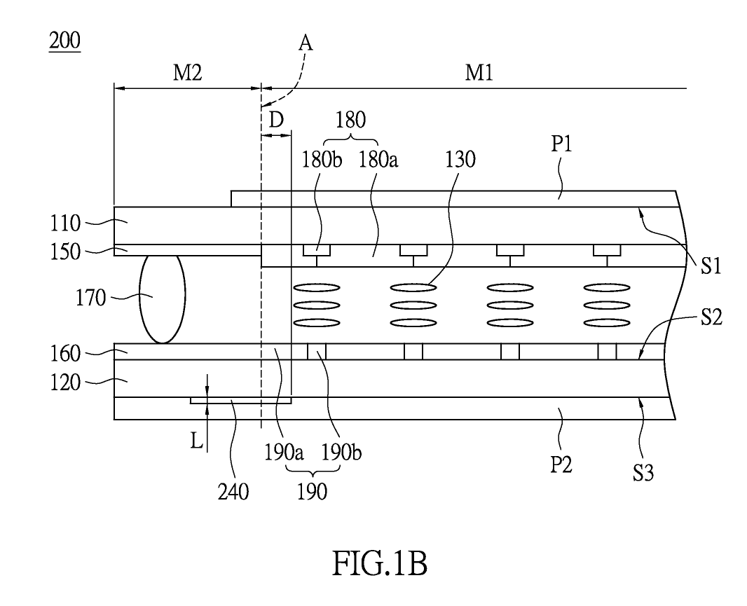

FIG. 1A is a cross-sectional view of a display panel in accordance with a first embodiment of the present disclosure. Please refer to FIG. 1A. The display panel 100 includes a first substrate 110, a second substrate 120, a liquid crystal layer 130 and a light shielding layer 140. The first substrate 110 and second substrate 120 are joined together. The liquid crystal layer 130 is disposed between the first substrate 110 and second substrate 120.

The display panel 100 has a display area M1 and a non-display area M2 surrounding the display area M1. The first substrate 110 has a first lower surface S1. The second substrate 120 has a second upper surface S2 and a second lower surface S3. The first lower surface S1 faces the second upper surface S2, and the second upper surface S2 is opposite to the second lower surface S3. The second lower surface S3 defines a boundary line A, which is corresponding to the display area M1 and the non-display area M2. Generally, the first substrate 110 and the second substrate 120 are transparent insulating substrates made of glass, plastic or quartz. The instant disclosure does not limit the materials of these substrates 110 and 120.

A color filter layer 180 can be disposed on the first substrate 110 in the display area M1 to form a color filter substrate. The color filter layer 180 includes a plurality of color filters 180a with various colors and a light-shielding film 180b. The color filters 180a are photoresists of various colors, and the material of the color filters 180a may be photoresist material. The color of the color filters 180a may be red, green, blue, and so on. Partial surface of the first substrate 110 is exposed through the light-shielding film 180b to be partitioned into a plurality of monochromatic pixel regions (not shown). The color filters 180a with various colors are disposed in these mono color pixel regions. The material of the light-shielding film 180b may be black resin, black photoresist, and so on. The light-shielding film 180b is used to shield light. Hence, the light-shielding film 180b can reduce the effect of color-mixing by adjacent color filters 180a on image performance. In addition, for product design, the configuration of the color filters 180a may be mosaic type, delta type, and stripe type.

In addition, in another embodiment, the color filter layer 180 may be disposed on the second substrate 120, whereas the color filter layer 180 may not be disposed on the first substrate 110, i.e. a COA (color filter on array) structure. However, the instant disclosure does not limit the arrangements of the color filter layer 180, the colors and materials of the color filters 180a.

A black matrix layer 150 is disposed in the non-display area M2, and between the first substrate 110 and the second substrate 120. The materials of the black matrix layer 150 may be black photosensitive resin, black photoresist, and so on. In practice, the black matrix layer 150 is disposed on the first substrate 110 or the second substrate 120. Moreover, for the manufacturing process and the cost concern, the black matrix layer 150 and the light shutters 180b may be made of different types of black photosensitive resins or black photoresist materials and may be formed in different manufacturing steps. However, the black matrix layer 150 is not especially limited in the invention.

The display panel 100 further comprises an active element array layer 190 including a plurality of active elements 190a, a plurality of data lines 190b and scanning lines (not shown), wherein the active elements 190a are electrically connected to the data lines 190b and the scanning lines. The active elements 190a, data lines 190b and scanning lines are all disposed on the second substrate 120, and the active elements 190a are disposed in the display area M1. The active element array is configured by the active elements 190a aligned with the color filters 180a. A trace layer 160 is disposed in the non-display area M2. Accordingly, an active element array substrate is formed.

The liquid crystal layer 130 is interposed in a gap between the first lower surface S1 and the second upper surface S2 to control the incident light. In the embodiment, the liquid crystal layer 130 can be made of various types of materials, such as, nematic liquid crystals, smectic liquid crystals, cholesteric liquid crystals, and so on. However, the instant disclosure does not limit the types of materials of the liquid crystal layer 130.

An adhesive layer 170 is a bonding agent, which is capable of joining the first substrate 110 and the second substrate 120 together. In an embodiment, the adhesive layer 170 is disposed on the non-display area M2 and surrounding the visible region M1. The adhesive layer 170 is provided for adhering the color filter substrate and the active element array substrate. Generally, the main material of the adhesive layer 170 is epoxy resin. The adhesive layer 170 may be thermo-curing and photo-curing resin according to the curing process. However, the instant disclosure does not limit this.

The light shielding layer 140 is disposed on the second lower surface S3 of the second substrate 120. The light shielding layer 140 is in frame shape, and at least a portion of light shielding layer 140 is disposed within the non-display area M2. That is, the light shielding layer 140 is disposed on the surface of the second substrate 120 that is not in contact with the liquid crystal layer 130. The second lower surface S3 defines a boundary line A corresponding to the boundary between the display area M1 and the non-display area M2. In practice, the light shielding layer 140 is adjacent to the boundary line A, and there is a shortest distance D between an edge of the light shielding layer 140 and the boundary line A. That is to say, the light shielding layer 140 is disposed on the non-display area M2, whereas the inner edge of the light shielding layer 140 is spaced apart from the boundary line A by the shortest distance D. The shortest distance D is derived from the process tolerances. The shortest distance D is more than 0 micron (μm) and equal or less than 100 micron (μm).

FIG. 1B is a cross-sectional view of a display panel in accordance with a second embodiment of the instant disclosure. The display panel 200 in accordance with the second embodiment is similar to the display panel 100 in accordance with the first embodiment. The following detailed description explains the difference between the display panel 100 and the display panel 200, and the common features are not described again. Please refer to FIG. 1B. The light shielding layer 240 is disposed on the second lower surface S3 of the second substrate 120. The light shielding layer 140 is in frame shape and surrounding the display area M1. In practice, the light shielding layer 240 is adjacent to the boundary line A, and there is a shortest distance D between an edge of the light shielding layer 240 and the boundary line A. The light shielding layer 240 covers the boundary line A of the second lower surface S3. That is to say, the extent of the light shielding layer 240 forms a shortest distance D from the non-display area M2 to the display area M1. The shortest distance D is derived from the process tolerances, wherein the shortest distance D is more than 0 micron (μm) and equal or less than 100 micron (μm).

The light shielding layer 140 and 240 may be made of black photosensitive resin, black photoresist material or the like such as positive-type photosensitive resin or negative-type photosensitive resin material. The thickness L of the light shielding layer 140 and 240 made of the black photosensitive resin is between 2 micron (μm) and 4 micron (μm). Alternatively, the light shielding layer 140 and 240 may be made of metallic material such as Aluminum (Al), Molybdenum (Mo), Chromium (Cr) or the like. The thickness L of the light shielding layer 140 and 240 made of metallic material is between 0.08 micron (μm) and 0.2 micron (μm).

The display panel 100 and 200 may further include an upper polarizing film P1 and a lower polarizing film P2. In general, the upper polarizing film P1 and the lower polarizing film P2 are disposed on the surface of the first substrate 110 and the second lower surface S3 of the second substrate 120 respectively. That is to say, the upper polarizing film P1 is disposed on the surface of the first substrate 110 which is not in contact with the liquid crystal layer 130, whereas the lower polarizing film P2 is disposed on the surface of the second substrate 120 which is not in contact with the liquid crystal layer 130. The lower polarizing film P2 at least partially covers the light shielding layer 140 and 240. The display panel 100 and 200 can provide a brightness control by utilizing the polarized light which is obtained by the upper polarizing film P1, the lower polarizing film P2 and the twist properties of liquid crystal.

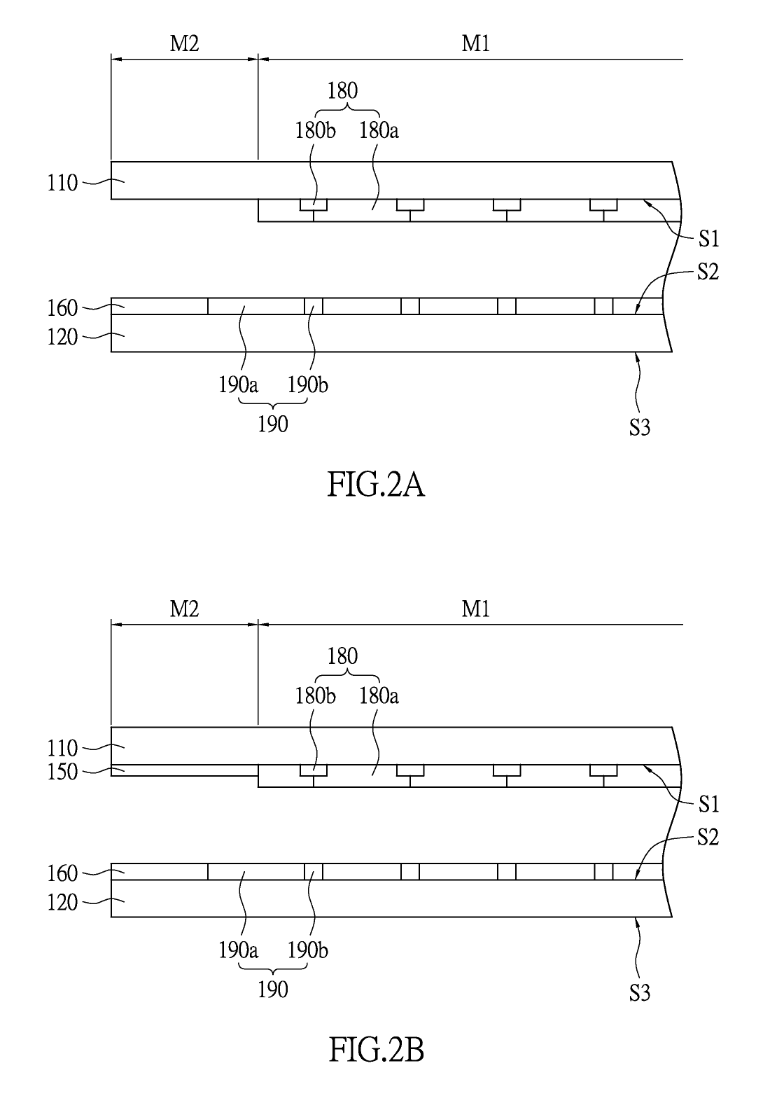

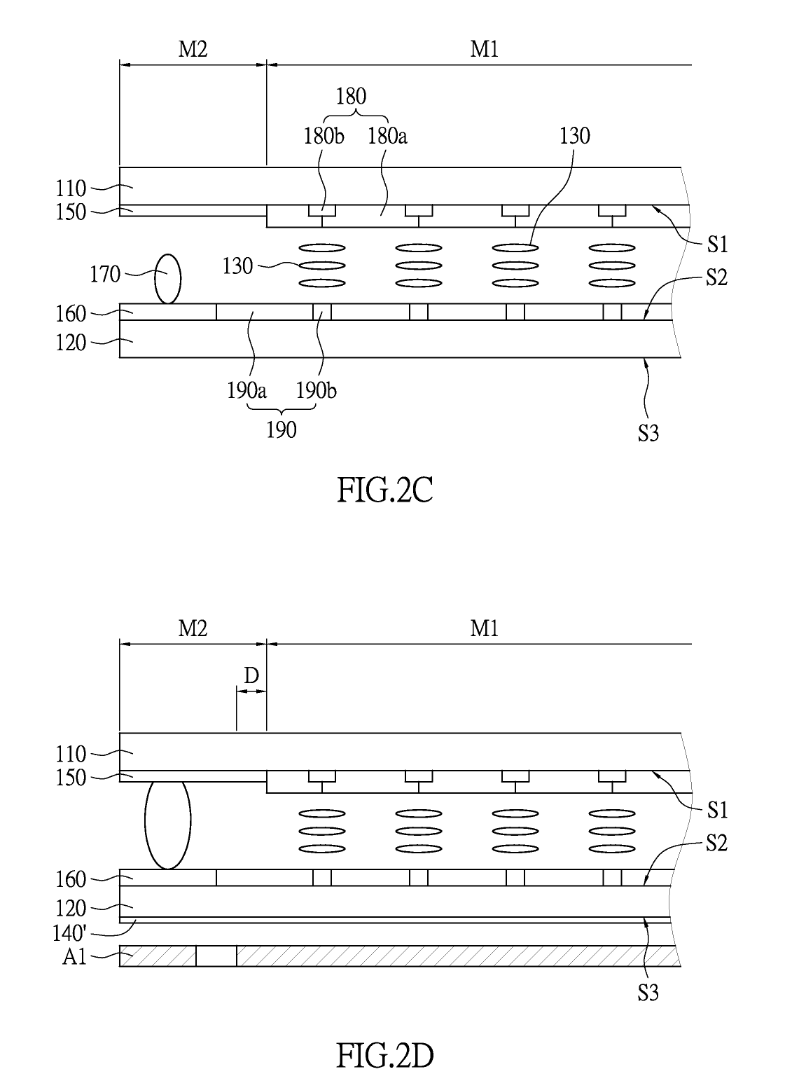

FIG. 2A-2D are schematic views illustrating steps an display panel manufacturing method in accordance with the first embodiment of the instant disclosure.

Please refer to FIG. 2A. Specifically, first, the first substrate 110 and the second substrate 120 is provided. The first substrate 110 includes the first lower surface S1, and the second substrate 120 has the second upper surface S2 and the second lower surface S3 opposite to the second upper surface S2. It is worth to note that the color filter layer 180 is formed in the display area M1 so that a color filter substrate is formed. Partial surface of the first substrate 110 is exposed through the light-shielding film 180b to be partitioned into a plurality of monochromatic pixel regions (not shown). The color filters 180a with various colors are arranged in these mono color pixel regions in many types, such as mosaic type, delta type, stripe type or the like. However, the instant disclosure does not limit this. In addition, the active element array layer 190 is formed in the display area M1 and includes a plurality of active elements 190a, data lines 190b and scanning lines. The trace layer 160 is disposed in the non-display area M2. Accordingly, the active element array substrate is formed.

Please refer to FIG. 2B, the black matrix layer 150 is formed on one of surface of the first substrate 110 and the second substrate 120. In this embodiment, the black matrix layer 150 is formed on the underside of the first substrate 110. Namely, the black matrix layer 150 is formed on first lower surface S1 of the first substrate 110 which is in contact with the liquid crystal layer 130.

Please refer to FIG. 2C, the adhesive layer 170 is formed on the second substrate 120 in the non-display area M2. The adhesive layer 170 is formed in frame shape and disposed surrounding the display area M1. Then, the liquid crystal layer 130 is formed on the second upper surface S2 of the second substrate 120 and disposed in the region surrounded by the adhesive layer 170.

Please refer to FIG. 2D, the first substrate 110 is positioned to be aligned with the second substrate 120. Then, the first substrate 110 and the second substrate 120 are joined by the adhesive layer 170.

Next, a covering layer 140′ is formed and covers on the second lower surface S3 of the second substrate 120. A photomask A1 is disposed above the covering layer 140′, and then the light shielding layer 140 is formed through the photomask A1 by using a photolithography process. The light shielding layer 140 is in frame shape. It is worth to note that the light shielding layer 140 may stray from the boundary line A corresponding to the boundary between the display area M1 and the non-display area M2 due to process tolerances in the fabrication process. Thereby, there is a shortest distance D between the inner edge of the light shielding layer 140 and the boundary of the display area M1. The shortest distance D is more than 0 micron (μm) and equal or less than 100 micron (μm). The thickness L of the light shielding layer 140 made by the black photosensitive resin is between 0.08 micron (μm) and 4 micron (μm).

Specifically, the covering layer 140′ is coated with black photosensitive material through spin coating on the second lower surface S3 of the second substrate 120. For example, positive-type or negative-type photosensitive resin materials are coated on the second lower surface S3 of the second substrate 120 to form the covering layer 140′. The black photosensitive material is exposed through the photomask A1, and then the developed process is performed to form the light shielding layer 140. The thickness L of the light shielding layer 140 made by the photosensitive material is between 2 micron (μm) and 4 micron (μm).

Moreover, in other embodiment, the covering layer 140′ can be formed by coating metal film on the second lower surface S3 of the second substrate 120. For example, Aluminum (Al), Molybdenum (Mo), Chromium (Cr) or the like can be coated on the second lower surface S3 of the second substrate 120 through spray plating or sputtering to form the covering layer 140′. Thereafter, a photoresist material (not shown) is formed and covers on the covering layer 140′. The exposing and developing processes are performed on the photoresist material by using the photomask A1 to define the pattern of the light shielding layer 140. Then, the metallic material which is not covered by the photoresist material is removed through etchant to form the light shielding layer 140 from part of the covering layer 140′. The remaining photoresist material is removed. The thickness of the light shielding layer 140 made of the metal is between 0.08 micron (μm) and 0.2 micron (μm).—

The manufacturing precision of the light shielding layer can be improved by using the photolithography process, and thereby the shortest distance between the inner edge of the light shielding layer and the border of the display area can be reduced. In addition, the thickness of the light shielding layer can be reduced by using the photolithography process. Hence, the probability of generating air bubbles which may be generated during attaching the lower polarizing film to the light shielding layer is reduced by reducing the level difference between the lower polarizing film and the light shielding layer.

In summary, the instant disclosure provides the light shielding layer. The light shielding layer is located on the second lower surface of the second substrate. In comparison with the space between conventional black matrix and back light module, the shortest distance between the light shielding layer and back light module is shorter. Namely, the light shielding layer is more close to back light module. Hence, it is possible to reduce the incident light leakage of the backlight module, thereby reducing the probability of large angle light leakage.

In addition, the embodiments of the instant disclosure provide a method for manufacturing display panel. The method of manufacturing display panel is used to produce the light shielding layer by using a photolithography process. A frame-shaped light shielding layer surrounding the display area is formed by using a photomask on the covering layer. In practice, there is a shortest distance between the inner edge of the light shielding layer and the boundary of the display area, and the shortest distance is derived from the assembly tolerances (assembly-related tolerances). The manufacturing precision of the light shielding layer can be improved by using the photolithography process. In addition, the thickness of the light shielding layer can be reduced by using the photolithography process. Hence, the probability of generating air bubbles which may be generated during the attaching of the lower polarizing film to the light shielding layer is reduced by reducing the level difference between the lower polarizing film and the light shielding layer. Hence, the manufacturing precision of the light shielding layer is high, and the thickness of the light shielding layer is thin so that it can be more suitable for a narrow border display device.

The above-mentioned descriptions represent merely the exemplary embodiment of the instant disclosure, without any intention to limit the scope of the instant disclosure thereto. Various equivalent changes, alternations or modifications based on the claims of instant disclosure are all consequently viewed as being embraced by the scope of the present disclosure.

What is claimed is:

1. A display panel having a display area and a non-display area surrounding the display area, comprising:
a first substrate having a first lower surface;
a second substrate having a second upper surface and a second lower surface opposite to the second upper surface;
a liquid crystal layer disposed between the first lower surface and the second upper surface; and
a light shielding layer disposed on the second lower surface of the second substrate and at least a portion of the light shielding layer disposed within the non-display area, wherein the thickness of the light shielding layer is between 0.08 micrometer and 4 micrometer.

2. The display panel according to claim 1, wherein the light shielding layer is made of a black photosensitive resin material.

3. The display panel according to claim 2, wherein the thickness of the light shielding layer is between 2 micrometer and 4 micrometer.

4. The display panel according to claim 1, wherein the light shielding layer is made of metallic material.

5. The display panel according to claim 4, wherein the thickness of the light shielding layer is between 0.08 micrometer and 0.2 micrometer.

6. A display panel having a display area and a non-display area surrounding the display area, comprising:
a first substrate having a first lower surface;
a second substrate having a second upper surface and a second lower surface opposite to the second upper surface, wherein the second lower surface defines a boundary line corresponding to the boundary between the display area and the non-display area;
a liquid crystal layer disposed between the first lower surface and the second upper surface; and
a light shielding layer disposed on the second lower surface of the second substrate and adjacent to the boundary line, wherein there is a shortest distance D between an edge of the light shielding layer and the boundary line;
wherein the shortest distance D is larger than 0 micrometer and equal or less than 100 micrometer.

7. The display panel according to claim 6, wherein the light shielding layer is made of black photosensitive resin material.

8. The display panel according to claim 6, wherein the light shielding layer is made of metallic material.

9. The display panel according to claim 6, wherein the light shielding layer covers the boundary line of the second lower surface.

10. The display panel according to claim 6, wherein the light shielding layer does not cover the boundary line of the second lower surface.

11. A method for manufacturing a display panel, comprising:
providing a first substrate and a second substrate, wherein the first substrate includes a first lower surface, and the second substrate has a second upper surface and a second lower surface opposite to the second upper surface;
providing a liquid crystal layer between the first lower surface and the second upper surface;
joining the first substrate and the second substrate; and
forming a light shielding layer on the second lower surface of the second substrate by using a photolithography process.

12. The method for manufacturing the display panel according to claim 11, wherein the photolithography process further comprises the steps of:
coating a photoresist material on the second lower surface of the second substrate; and
patterning the photoresist material to form the light shielding layer.

13. The method for manufacturing the display panel according to claim 11, wherein the light shielding layer is made of black photosensitive resin material.

14. The method for manufacturing the display panel according to claim 11, wherein the photolithography process further comprises the steps of:
forming a metal film on the second lower surface of the second substrate;
forming a photoresist material on the metal film;
patterning the photoresist material;
etching a part of the metal film which is not covered by the photoresist material to form the light shielding layer; and
removing the photoresist material.
